(19) United States
(12) Patent Application Publication
(10) Pub. No.: US 2006/0101163 A1
(43) Pub. Date: May 11, 2006

(54) Method for a host computer to detect motion message of a wireless mouse

(76) Inventor: Ho-Lung Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/982,766

(22) Filed: Nov. 8, 2004

(51) Int. Cl. G06F 3/00

(52) U.S. Cl. 710/15

(57) ABSTRACT

A method for a host computer to detect the motion message of a wireless mouse has the following steps of: gathering statistics regarding information of the host computer; receiving ID authentication information from the wireless mouse; informing a firmware in the wireless mouse to activate a user-specific mode; supervising action information of the wireless mouse; determining whether to change action parameters of the wireless mouse based on action responses of the wireless mouse; and informing and changing the action parameters of the wireless mouse. The delay situation of the wireless mouse due to wireless transmission when moving on a computer screen can thus be improved.

### BACKGROUND OF THE INVENTION

1. Field of the invention

The present invention relates to a method for a host computer to detect the motion message of a wireless mouse and, more particularly, to a method of using a program to detect the motion speed of a wireless mouse to lessen the delay of the wireless mouse due to wireless transmission when moving on a computer screen.

2. Description of Related Art

Due to continual technology enhancement, computer peripherals have found new ways of doing things from old theories. With input apparatuses of computer as an example, keyboards or mice have transformed from the original, wired type to the novel, wireless type.

Although a wireless mouse is a big improvement in hardware architecture, it also adds a large software load. In the prior art, it has been found that software matching a wireless mouse will influence a user's liking for the wireless mouse. For example, in order to meet software specifications of the Window operation system of Microsoft, Inc., there will easily be a delay situation of cursor of a wireless mouse when moving on a computer screen.

### SUMMARY OF THE INVENTION

Accordingly, one object of the present invention is to propose a method for a host computer to detect the motion message of a wireless mouse to solve the above problems in the prior art.

The present invention provides a method for a host computer to detect the motion message of a wireless mouse. The method comprises the steps of: gathering statistics of information of the host computer; receiving ID authentication information from the wireless mouse; informing a firmware in the wireless mouse to activate a user-specific mode; reading out a user's habitual preference or a wireless mouse's habitude from a database; storing information required to be set in the wireless mouse in the host computer and sending the information to the wireless mouse for setting; supervising action information of the wireless mouse; gathering statistics of action information of the wireless mouse; determining whether to change action parameters of the wireless mouse based on action responses of the wireless mouse; and informing and changing the action parameters of the wireless mouse. The,present invention can improve the delay situation of the wireless mouse due to wireless transmission when moving on a computer screen.

### BRIEF DESCRIPTION OF THE DRAWINGS

The various objects and advantages of the present invention will be more readily understood from the following detailed description when read in conjunction with the appended drawing, in which:

FIG. 1 is a flowchart of a method for a host computer to detect the motion message of a wireless mouse according to an embodiment of the present invention; and

FIG. 2 is a flowchart of a method for a wireless mouse to receive the motion message according to an embodiment of the present invention.

### DETAILED DESCRIPTION OF THE PREFERRED EMBODIMENTS

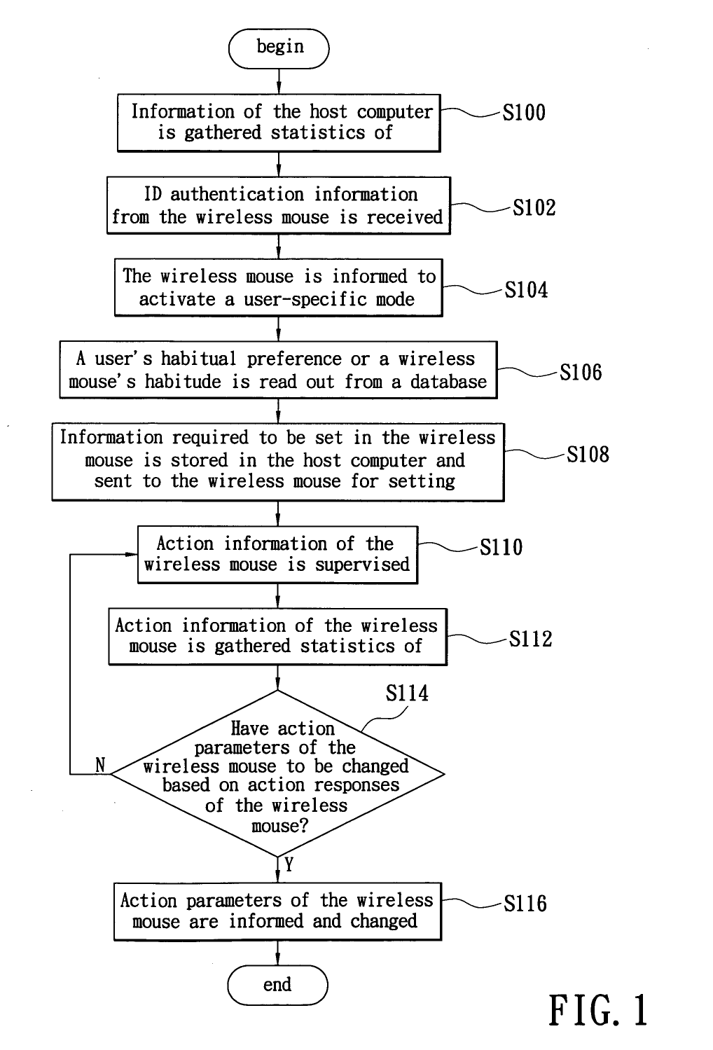

FIG. 1 is a flowchart of a method for a host computer to detect the motion message of a wireless mouse according to an embodiment of the present invention. First, statistics regarding information of the host computer are gathered (Step S100). The information of the host computer is about the present usable resources of the host computer. Next, ID authentication information from the wireless mouse is received (Step S102). The ID authentication information is used to determine whether the wireless mouse is authenticated. The wireless mouse is then informed to activate a user-specific mode (Step S104). A user's habitual preference or a wireless mouse's habitude is read out from a database (Step S106). The database can be in the wireless mouse or the host computer.

Subsequently, information required to be set in the wireless mouse is stored in the host computer and sent to the wireless mouse for setting (Step S108). Action information of the wireless mouse is supervised (Step S110). Statistics regarding the action information of the wireless mouse are gathered (Step S112). Whether action parameters of the wireless mouse have to be changed based on action responses of the wireless mouse is determined (Step S114). If the answer is yes, action parameters of the wireless mouse are informed and changed (Step S116); otherwise, the process returns to Step S110.

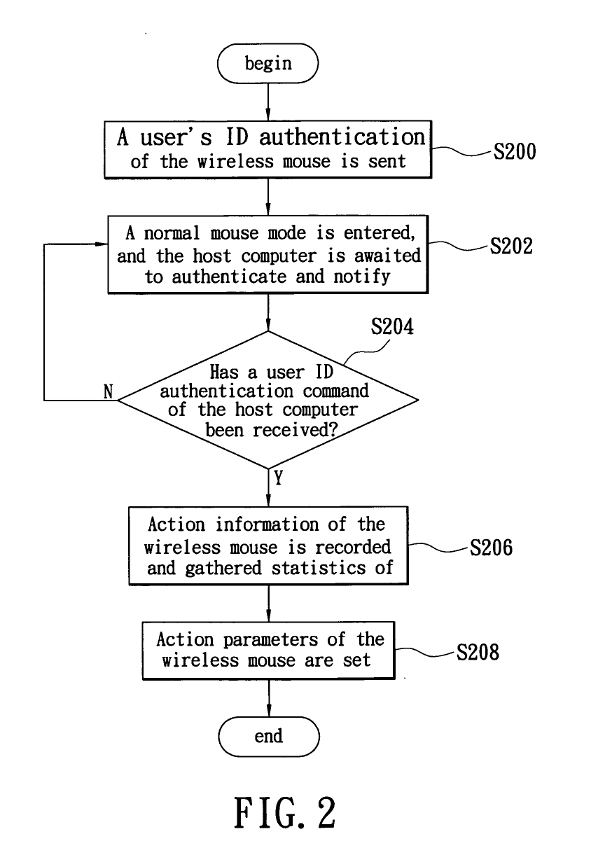

FIG. 2 is a flowchart of a method for a wireless mouse to receive the motion message according to an embodiment of the present invention. First, a user's ID authentication of the wireless mouse is sent (Step S200) to a host computer. The user's ID authentication is used to determine whether the user is one stored in a database. Next, a normal mouse mode is entered, and the process waits for the host computer to authenticate and notify (Step S202). Whether a user ID authentication command of the host computer has been received is determined (Step S204). If the answer is yes, action parameters of the wireless mouse are set (Step S206); otherwise, the process returns to Step S202. Finally, action parameters of the wireless mouse are recorded and statistics thereof are gathered (Step S208).

To sum up, the present invention can reduce the delay situation of the wireless mouse due to wireless transmission when moving on a computer screen in the prior art.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method for a host computer to detect the motion message of a wireless mouse, comprising the steps of:
gathering statistics regarding information of said host computer;
receiving ID authentication information from said wireless mouse;
informing a firmware in said wireless mouse to activate a user-specific mode;
supervising action information of said wireless mouse;
determining whether to change action parameters of said wireless mouse based on action responses of said wireless mouse; and
informing and changing action parameters of said wireless mouse.

2. The method for a host computer to detect the motion message of a wireless mouse as claimed in claim 1, wherein said information of said host computer is about present usable resources of said host computer.

3. The method for a host computer to detect the motion message of a wireless mouse as claimed in claim 1, wherein said ID authentication information is used to determine whether said wireless mouse is authenticated.

4. The method for a host computer to detect the motion message of a wireless mouse as claimed in claim 1, wherein said step of informing a firmware in said wireless mouse to activate a user-specific mode further comprises:
reading out a user's habitual preference or a wireless mouse's habitude from a database; and
storing information required to be set in said wireless mouse in said host computer and sending the information to said wireless mouse for setting.

5. The method for a host computer to detect the motion message of a wireless mouse as claimed in claim 4, wherein said database is in said wireless mouse or said host computer.

6. The method for a host computer to detect the motion message of a wireless mouse as claimed in claim 1, further comprising a step of gathering statistics regarding action information of said wireless mouse after said step of supervising action information of said wireless mouse.

7. The method for a host computer to detect the motion message of a wireless mouse as claimed in claim 1, wherein if an answer is yes in said step of determining whether to change action parameters of said wireless mouse based on action responses of said wireless mouse, said step of informing and changing action parameters of said wireless mouse is performed, and otherwise the method returns to said step of supervising action information of said wireless mouse.

8. A method for a wireless mouse to receive the motion message, comprising the steps of:
sending a user's ID authentication of said wireless mouse to a host computer;
determining whether a user ID authentication command of said host computer has been received; and
recording and gathering statistics regarding action parameters of said wireless mouse.

9. The method for a wireless mouse to receive the motion message as claimed in claim 8, wherein said user's ID authentication is used to determine whether said user is one stored in a database.

10. The method for a wireless mouse to receive the motion message as claimed in claim 8, further comprising a step of entering a normal wireless mouse mode and waiting for said host computer to authenticate and notify after said step of sending a user's ID authentication of said wireless mouse to a host computer.

11. The method for a wireless mouse to receive the motion message as claimed in claim 8, wherein if an answer is yes in said step of determining whether a user's ID authentication command of said host computer has been received, said step of recording and gathering statistics of action parameters of said wireless mouse is performed, and otherwise the method returns to a step of entering a normal wireless mouse mode and waiting for said host computer to authenticate and notify.

12. The method for a wireless mouse to receive the motion message as claimed in claim 8, further comprising a step of setting action parameters of said wireless mouse after said step of recording and gathering statistics of action parameters of said wireless mouse.
